(19) United States
(12) Patent Application Publication
(10) Pub. No.: US 2021/0315209 A1
(43) Pub. Date: Oct. 14, 2021

(54) AEROSOL AGENT FOR INSECT PEST CONTROL AND INSECT PEST CONTROL METHOD

(71) Applicant: DAINIHON JOCHUGIKU Co., Ltd., Osaka (JP)

(72) Inventors: Yuya HARADA, Osaka (JP); Yoko KOBAYASHI, Osaka (JP); Yumi KAWAJIRI, Osaka (JP); Koji NAKAYAMA, Osaka (JP)

(21) Appl. No.: 17/267,305

(22) PCT Filed: Aug. 6, 2019
(86) PCT No.: PCT/JP2019/030819

§ 371 Date: Feb. 9, 2021

(30) Foreign Application Priority Data
Aug. 20, 2018 (JP) 2018-153840

(51) Int. Cl. A01N 53/00; A01N 25/06; A01N 25/30

(52) U.S. Cl. CPC A01N 53/00; A01N 25/30; A01N 25/06

(57) ABSTRACT

An outdoor aerosol agent for insect pest control useful for insect pests with reduced sensitivity to pyrethroid-based insecticidal components, particularly mosquitoes, having excellent adhesion to surfaces to be treated and effectiveness of formation of a barrier space without causing issues with VOC regulations. The aerosol agent is obtained by filling a pressure-resistant container with an aerosol stock solution and a propellant, wherein VOC content in the aerosol stock solution is 30% by mass or less, the aerosol stock solution including: (a) 0.01 to 3.0% by mass of a room-temperature volatile pyrethroid-based insecticidal component that has a vapor pressure of 2×10⁻⁴ to 1×10⁻² mmHg at 30° C.; (b) 0.5 to 10% by mass of a glycol ether compound having a boiling point of 160 to 320° C.; (c) 0.2 to 5.0% by mass of a nonionic surfactant and/or an anionic surfactant; and (d) the remainder % by mass being water.

### TECHNICAL FIELD

The present invention relates to an aerosol agent for insect pest control obtained by filling a pressure-resistant container provided with a spray button, with an aerosol stock solution and a propellant, and an insect pest control method using the same.

### BACKGROUND ART

In general, aerosol agents for insect pest control used outdoors are classified into the following types, according to their usage: (1) a direct-attack type, i.e., a type of spraying an aerosol agent directly to insect pests flying in outdoor spaces; (2) a type of spraying an aerosol agent around plant bodies or shadowy areas or their whole nearby spaces for the purpose of controlling insect pests hiding behind trees and leaves or in the shades; and (3) a type of ambushing insect pests by atomizing and applying an aerosol insecticide in advance onto solid-phase surfaces of exterior walls, windowpanes, the ground, and the like. Basically, the direct-attack type (1) requires the fast-acting property and thus generally utilizes phthalthrin or the like, which is a fast-acting pyrethroid-based insecticidal component. On the other hand, the ambushing type (3) requires the residual efficacy and thus often utilizes an insecticidal component with low vapor pressure and poor volatilizing property.

In recent years, there are the increasing number of people who spend their leisure time more outdoors (including terraces, balconies, etc.), which is called outdoor lifestyle, or engage themselves in home gardening or yard work. Because of this, there are more opportunities for people to get bothered by insect pests, especially mosquitoes, typified by aedes mosquitoes, in the vicinity of trees, shady areas, and the like, which leads to an increasing need for aerosol agents for insect pest control of the above type (2)

Regarding the type (2) described above, there is an attempt to control flying insect pests so as to protect people from them, by dispersing a water-based aerosol agent containing an insecticidal component with relatively high vapor pressure, onto a solid-phase surface under the environment where insect pests are flying, thereby forming an insecticidal component barrier. For example, Patent Document 1 (Japanese Patent Publication No. 4703172) describes that an outdoor one-component water-based aerosol agent is atomized and applied to the entire surface of a tent fabric to form a barrier containing a pyrethroid-based insecticidal component around the tent, and this barrier prevents flying insect pests from entering the tent for 10 hours or more. Here, the water-based aerosol agent is composed of 30 to 70% by volume of an aerosol stock solution containing a room-temperature volatile pyrethroid-based insecticidal component, a lower alcohol having carbon atoms of 1 to 3, a glycol having carbon atoms of 3 to 6, and water, and 30 to 70% by volume of a propellant containing dimethyl ether, with a pH of the aerosol stock solution being in the range of 5 to 7. However, since the aerosol agent of Patent Document 1 uses a volatile organic compound (hereinafter abbreviated as VOC) as the propellant, there remain some problems to be addressed in terms of the environment.

Patent Document 2 (Japanese Unexamined Patent Application Publication No. 2010-161957) discloses a method of preventing invasion of insect pests by using an aerosol agent that contains a room-temperature volatile pyrethroid-based insecticidal component and a glycol having carbon atoms of 3 to 6 as a volatilization regulator thereof and is filled with compressed gas as a propellant. The method includes atomizing the aerosol agent with an average atomized particle size of 50 to 150 μm such that the treatment amount of the room-temperature volatile pyrethroid-based insecticidal component is greater than or equal to 0.5 mg/m² on a surface to be treated, thereby forming a barrier space of the room-temperature volatile pyrethroid-based insecticidal component above the surface to be treated, which prevents the invasion of insect pests into this space for six hours or more. Compared to Patent Document 1, it can be said that the technology described in Patent Document 2 is designed by taking into consideration the environment to some extent that the compressed gas is used instead of dimethyl ether as the propellant.

However, VOC regulations are becoming stricter year by year. For example, in the circumstances of the United States, it is generally required to suppress the VOC content per product to 30% by mass or less and reduce the VOC content to 25% by mass or less for some types of products. The aerosol agent of Patent Document 2 is intended to blend 20 to 80 v/v % of a lower alcohol having carbon atoms of 2 or 3 into the aerosol agent in order to create a one-component, water-based formulation. However, there are still many cases where this type of aerosol agent cannot pass the VOC regulations of the United States.

Further, in both Patent Document 1 and Patent Document 2, insect pest control efficacy tests (as used herein, the term insect pest control effect implies a broad concept including an insecticidal effect, a repellent effect, an invasion preventing effect, and the like) are limited to insect pests that do not have reduced sensitivity to pyrethroid-based insecticidal components, but they do not refer to any insect pests with reduced sensitivity, particularly mosquitoes.

### CITATION LIST

### Patent Literature

Patent Literature 1: Japanese Patent Publication No. 4703172
Patent Literature 2: Japanese Unexamined Patent Application Publication No. 2010-161957

### SUMMARY OF INVENTION

### Technical Problem

With the above problems in mind, the present invention has been made on the condition that an aerosol agent for insect pest control, containing a room-temperature volatile pyrethroid-based insecticidal component, is sprayed onto a treatment target located outdoors, such as a terrace or a veranda, to form a barrier space of the room-temperature volatile pyrethroid-based insecticidal component above the treatment target, thereby exhibiting the insect pest control effect. It is an object of the present invention to provide an outdoor aerosol agent for insect pest control and an insect pest control method using the aerosol agent for insect pest control which are useful for insect pests with reduced sensitivity to pyrethroid-based insecticidal components, particularly mosquitoes, while being excellent in adhesion to a surface to be treated and in effectiveness of formation of a barrier space obviously without causing any issues in terms of the VOC regulations.

### Solution to Problem

The present invention has found that the following configurations exhibit excellent effects in achieving the above object.

(1) An aerosol agent for insect pest control includes an aerosol stock solution and a propellant, the aerosol agent being obtained by filling a pressure-resistant container provided with a spray button, with the aerosol stock solution and the propellant, wherein a VOC content in the aerosol stock solution is 30% by mass or less, the aerosol stock solution including:

(a) 0.01 to 3.0% by mass of a room-temperature volatile pyrethroid-based insecticidal component that has a vapor pressure of 2×10⁻⁴ to 1×10⁻² mmHg at 30° C.;

(b) 0.5 to 10% by mass of a glycol ether compound having a boiling point of 160 to 320° C.;

(c) 0.2 to 5.0% by mass of a nonionic surfactant and/or an anionic surfactant; and

(d) the remainder in % by mass being water.

(2) In the aerosol agent for insect pest control described in (1), when the aerosol stock solution is sprayed from the spray button onto an outdoor treatment target together with the propellant such that a treatment amount of the room-temperature volatile pyrethroid-based insecticidal component (a) is within a range of 0.5 to 20 mg/m², 60% by mass or more of the aerosol stock solution adheres to a surface of the treatment target, and

the room-temperature volatile pyrethroid-based insecticidal component (a) contained in the aerosol stock solution is volatilized from the surface for four hours or more.

(3) In the aerosol agent for insect pest control described in (1) or (2), the VOC content is 25% by mass or less.
(4) In the aerosol agent for insect pest control described in any one of (1) to (3), the propellant is a compressed gas and/or HFO gas having a GWP value of 10 or less.
(5) In the aerosol agent for insect pest control described in any one of (1) to (4), the aerosol stock solution further contains (e) 15% by mass or less of a lower alcohol having carbon atoms of 2 or 3.
(6) In the aerosol agent for insect pest control described in any one of (1) to (5), an insect pest with reduced sensitivity to a pyrethroid-based insecticidal component is to be controlled.
(7) In the aerosol agent for insect pest control described in (6), the insect pest is a mosquito.
(8) In the aerosol agent for insect pest control described in any one of (1) to (7), the room-temperature volatile pyrethroid-based insecticidal component is at least one selected from the group consisting of transfluthrin, metofluthrin, and profluthrin.
(9) In the aerosol agent for insect pest control described in (8), the room-temperature volatile pyrethroid-based insecticidal component is transfluthrin.
(10) In the aerosol agent for insect pest control described in any one of (1) to (9), the glycol ether compound is an aromatic-based glycol ether compound.
(11) In the aerosol agent for insect pest control described in (10), the aromatic-based glycol ether compound is at least one selected from the group consisting of ethylene glycol monophenyl ether, ethylene glycol monobenzyl ether, diethylene glycol monophenyl ether, diethylene glycol monobenzyl ether, and propylene glycol monophenyl ether.
(12) In the aerosol agent for insect pest control described in any one of (1) to (11), the nonionic surfactant is at least one nonionic surfactant selected from the group consisting of a polyoxyethylene alkyl ether, a polyoxyethylene alkylphenyl ether, polyoxyethylene styryl phenyl ether, a polyoxyethylene-polyoxypropylene alkyl ether, a polyethylene glycol fatty acid ester, a polyoxyethylene sorbitan fatty acid ester, a polyoxyethylene glycerol fatty acid ester, and a fatty acid polyalkanolamide, and

the anionic surfactant is at least one anionic surfactant selected from the group consisting of a polyoxyethylene styryl phenyl ether sulfate, a polyoxyethylene alkyl ether sulfate, and a dodecyl benzene sulfate.

(13) In the aerosol agent for insect pest control described in any one of (1) to (12), an average particle size of the aerosol stock solution sprayed from the spray button is within a range of 70 to 160 μm.
(14) In the aerosol agent for insect pest control described in any one of (1) to (13), the treatment target is a floor surface of an outdoor terrace, a floor surface of an outdoor veranda, a surface of a vinyl sheet installed outdoors, or an outdoor ground.
(15) An insect pest control method includes the steps of: spraying the aerosol agent for insect pest control described in any one of (1) to (14), onto an outdoor treatment target such that a treatment amount of the room-temperature volatile pyrethroid-based insecticidal component (a) is within a range of 0.5 to 20 mg/m²; and

volatilizing the room-temperature volatile pyrethroid-based insecticidal component (a) contained in the aerosol stock solution adhering to a surface of the treatment target, from the surface for four hours or more.

(16) In the insect pest control method described in (15), an insect pest with reduced sensitivity to a pyrethroid-based insecticidal component is to be controlled.
(17) In the insect pest control method described in (16), the insect pest is a mosquito.

### Effects of Invention

The aerosol agent for insect pest control of the present invention is extremely useful because it can avoid the VOC regulations even in the United States where the regulations are strict. According to the aerosol agent for insect pest control and the insect pest control method of the present invention, when the aerosol stock solution is sprayed from the spray button onto an outdoor treatment target together with the propellant (for example, low-GWP gas) such that a treatment amount of the room-temperature volatile pyrethroid-based insecticidal component (a) is within a range of 0.5 to 20 mg/m², 60% by mass or more of the aerosol stock solution adheres to a surface of the treatment target. Then, when the room-temperature volatile pyrethroid-based insecticidal component (a) is volatilized from the surface of the treatment target, a barrier space for controlling insect pests is formed above the treatment target for four hours or more. As a result, the aerosol agent can exhibit an excellent insect pest control effect not only on insect pests with high sensitivity to pyrethroid-based insecticidal components, but also insect pests (particularly, mosquitoes) with reduced sensitivity to pyrethroid-based insecticidal components.

### DESCRIPTION OF EMBODIMENTS

In recent years, VOC regulations have been getting stricter year by year due to environmental considerations. For example, in the circumstances of the United States, it is generally required to suppress the VOC content per product to 30% by mass or less and reduce the VOC content to 25% by mass or less, depending on the type of product. Volatile Organic Compounds (VOC) as used herein are defined as volatile organic compounds having a boiling point of 320° C. or lower. Specifically, VOCs include, but are not limited to, glycol ether compounds, any solvents, such as lower alcohols, ester-based solvents, hydrocarbon-based solvents, and ketone-based solvents, as well as any propellants, such as liquefied petroleum gas (LPG), dimethyl ether (DME), and hydrofluorocarbons, and the like, as long as they are volatile organic compounds having a boiling point of 320° C. or lower. A hydrofluoroolefin (HFO) gas is a volatile organic compound having a boiling point of 320° C. or lower, but according to the standards of the United States Environmental Protection Agency (EPA), the HFO gas is not considered to be a VOC. Therefore, the HFO gas is also treated herein as not being a VOC. As mentioned above, the aerosol agent of Patent Document 2 contains 20 v/v % or more of a lower alcohol having carbon atoms of 2 or 3 in order to create a one-component, water-based formulation, which makes it very difficult to pass the standards of the VOC regulations. Accordingly, the inventors have thought that a water-based aerosol formulation of a microemulsion type is consistent with the object of the present invention and diligently studied the formulation.

Further, insect pests, such as mosquitoes, with reduced sensitivity to the pyrethroid-based insecticidal components, are appearing all over the world today, and thus control measures therefor are urgently needed. In a case where the reduced sensitivity is due to the activation of a metabolic enzyme in insect pests, the blending of piperonyl butoxide is said to be effective, but no useful compound that replaces this component has yet been proposed. The inventors have considered that the present situation in which outdoor water-based aerosol agents are widely used as a means of mosquito control, and diligently made an in-depth study on the aerosol agents by reviewing the technologies described in the above-mentioned Patent Document 1 and Patent Document 2. As a result, the inventors have found that a glycol ether compound having a boiling point of 160 to 320° C., preferably an aromatic-based glycol ether compound, is specifically effective for insect pests with reduced sensitivity to pyrethroid-based insecticidal compounds, particularly mosquitoes, and that the effect of such a compound can be utilized as a sensitivity reduction coping agent, which leads to the completion of the present invention.

The aerosol agent for insect pest control of the present invention is an outdoor water-based aerosol agent in which a VOC content is 30% by mass or less, and it contains (a) 0.01 to 3.0% by mass and preferably 0.08 to 0.17% by mass of a room-temperature volatile pyrethroid-based insecticidal component with a vapor pressure of 2×10⁻⁴ to 1×10⁻² mmHg at 30° C. in an aerosol stock solution. Examples of the pyrethroid-based insecticidal component include transfluthrin, metofluthrin, profluthrin, empenthrin, furamethrin, terallethrin, dimefluthrin, meperfluthrin, heptafluthrin, and the like. Of these, transfluthrin, metofluthrin, and profluthrin are preferable, and transfluthrin is more preferable in consideration of the room-temperature volatility, insect pest control efficacy, stability, availability of compounds, and the like. The above-mentioned pyrethroid-based insecticidal components may be used alone, or two or more of them may be used in combination. In addition, if there are optical isomers or geometric isomers based on a chiral carbon in an acid portion or alcohol portion of the pyrethroid-based insecticidal component, each of these isomers or any mixture thereof is also included in the pyrethroid-based insecticidal component usable in the present invention. If the content of the room-temperature volatile pyrethroid-based insecticidal component (a) is less than 0.01% by mass, the insect pest control efficacy may be degraded. On the other hand, if the content thereof is more than 3.0% by mass, the properties of the water-based aerosol agent composition could be compromised.

The room-temperature volatile pyrethroid-based insecticidal component (a) used in the present invention exhibits a direct attack effect and a contact effect on various flying insect pests or creeping insect pests. Furthermore, the room-temperature volatile pyrethroid-based insecticidal component is gradually volatilized from the sprayed solid-phase surface (the treatment target) to form an insecticidal component barrier in an environmental space above the solid-phase surface, which can effectively contribute to the preventive control of flying insect pests. In the present invention, the insecticidal effect, the knockdown effect, the repellent effect, the insect pest invasion preventing effect, and the like are comprehensively included in and referred to as the insect pest control effect.

In the aerosol agent for insect pest control of the present invention, other insecticidal components may be blended as appropriate, in addition to the room-temperature volatile pyrethroid-based insecticidal component (a) in order to enhance the direct attack effect on insect pests when this effect is expected. Such insecticidal components include non-volatile pyrethroid-based compounds such as phthalthrin, resmethrin, cyfluthrin, phenothrin, permethrin, cyphenothrin, cypermethrin, allethrin, prallethrin, imiprothrin, momfluorothrin, and etofenprox; silicon-based compounds such as silafluofen; organophosphorous compounds such as dichlorvos and fenitrothion; carbamate compounds such as propoxur; and neonicotinoid-based compounds such as dinotefuran, imidacloprid and clothianidin. When blending a non-volatile pyrethroid compound, its blending amount is set such that it does not affect the volatilizing property of the room-temperature volatile pyrethroid-based insecticidal component.

The aerosol agent for insect pest control of the present invention contains (b) 0.5 to 10% by mass and preferably 1.0 to 5.0% by mass of a glycol ether compound having a boiling point of 160 to 320° C. in the aerosol stock solution, together with the room-temperature volatile pyrethroid-based insecticidal component (a). With such a blending amount, it is easy to suppress the VOC content with respect to the entire aerosol agent to 30% by mass or less, even when a lower alcohol described later is further added. Here, the glycol ether compound acts not only as a solvent for the room-temperature volatile pyrethroid-based insecticidal component, but also as the sensitivity reduction coping agent for insect pests with reduced sensitivity to the pyrethroid-based insecticidal component, particularly mosquitoes. That is, the glycol ether compound, which is consistent with the object of the present invention, can act as the sensitivity reduction coping agent to the pyrethroid-based insecticidal component, but not as a volatilization regulator of glycol compounds as disclosed in Patent Documents 1 and 2 (which can also be said to be a kind of efficacy enhancer because it enhances the persistence of the insect pest control effect). Conventionally, a compound that enhances the intrinsic insecticidal effect on insect pests with pyrethroid sensitivity is often referred to as an “efficacy enhancer”. However, a compound that lessens the reduction in the degree of the insect pest control effect when targeted to insect pests with reduced sensitivity is herein distinguished from the conventional “efficacy enhancer”, and this compound is defined as the “sensitivity reduction coping agent”. Although the mechanisms of action of both compounds are not clearly understood, the “efficacy enhancer” does not necessarily correspond to the “sensitivity reduction coping agent”. If the blending amount of the glycol ether compound is less than 0.5% by mass, the compound is less effective not only as a solvent, but also in suppressing the reduction in the degree of the insect pest control effect. On the other hand, even if the blending amount exceeds 10% by mass, the insect pest control effect is limited, and the amount of surfactant required to form a microemulsion increases, which may affect the properties of the water-based aerosol.

The glycol ether compounds (b) used in the aerosol agent for insect pest control of the present invention have a boiling point of 160 to 320° C. and are broadly classified into aliphatic glycol ether compounds and aromatic-based glycol ether compounds with an aromatic ring. Specific examples of the aliphatic glycol ether compound include diethylene glycol monomethyl ether (trade name: methyl diglycol, boiling point: 194° C.), triethylene glycol monomethyl ether (trade name: methyl triglycol, boiling point: 249° C.), diethylene glycol monoisopropyl ether (trade name: isopropyl diglycol, boiling point: 207° C.), ethylene glycol monobutyl ether (trade name: butyl glycol, boiling point: 171° C.), diethylene glycol monobutyl ether (trade name: butyl diglycol, boiling point: 231° C.), diethylene glycol monohexyl ether (trade name: hexyl diglycol, boiling point: 259° C.), diethylene glycol monoethyl hexyl ether (trade name: ethylhexyl diglycol, boiling point: 272° C.), dipropylene glycol monopropyl ether (trade name: propyl propylene diglycol, boiling point: 212° C.), dipropylene glycol monobutyl ether (trade name: butylpropylene diglycol, boiling point: 231° C.), and the like.

Examples of the aromatic-based glycol ether compound include ethylene glycol monophenyl ether (trade name: phenyl glycol, boiling point: 245° C.), ethylene glycol monobenzyl ether (trade name: benzyl glycol, boiling point: 256° C.), diethylene glycol monophenyl ether (trade name: phenyldiglycol, boiling point: 283° C.), diethylene glycol monobenzyl ether (trade name: benzyl diglycol, boiling point: 302° C.), propylene glycol monophenyl ether (trade name: phenyl propylene glycol, boiling point: 243° C.), and the like.

In the present invention, these glycol ether compounds may be used alone, or two or more of them may be used in combination. However, from the viewpoint of the compatibility with a surfactant described later, the action as the sensitivity reduction coping agent, and the like, it is found that the aromatic-based glycol ether compound is more preferable than the aliphatic glycol ether compound in terms of performance.

Propylene glycol (boiling point: 188° C.) described as a volatilization regulator in Patent 1 and Patent 2 is a different compound from the glycol ether compound used in the present invention and is found to be not so effective as the “sensitivity reduction coping agent”. In other words, a material serving as the “volatilization regulator” or “efficacy enhancer” does not necessarily act as the “sensitivity reduction coping agent”.

The aerosol agent for insect pest control of the present invention contains (c) 0.2 to 5.0% by mass of a nonionic surfactant and/or an anionic surfactant in order to prepare a water-based aerosol formulation of a microemulsion type. If the blending amount of the surfactant is less than 0.2% by mass, the microemulsion formation ability of the aerosol agent becomes inferior. On the other hand, if the blending amount of the surfactant is more than 5.0% by mass, there may cause a problem of stickiness on a sprayed surface or the like, and thus this condition is not preferred.

Examples of the nonionic surfactant include polyoxyethylene styryl phenyl ether (activator N-1), polyoxyethylene alkyl ethers (activator N-2), polyoxyethylene alkylphenyl ethers (activator N-3), polyoxyethylene-polyoxypropylene alkyl ethers (activator N-4), polyethylene glycol fatty acid esters (activator N-5), polyoxyethylene sorbitan fatty acid esters (activator N-6), polyoxyethylene glycerol fatty acid esters (activator N-7), fatty acid polyalkanolamides (activator N-8), and the like.

Examples of the anionic surfactant include polyoxyethylene styryl phenyl ether sulfates (activator A-1), polyoxyethylene alkyl ether sulfates (activator A-2), dodecyl benzene sulfates (activator A-3), and the like.

Although the above-mentioned surfactants may be used alone or two or more of them may be used in combination, it is preferred that at least one of each of the nonionic surfactant and the anionic surfactant is used in combination.

The aerosol agent for insect pest control of the present invention adopts an aqueous formulation prepared by the aerosol stock solution with water (d) from the viewpoint of solving the VOC issues and reducing chemical damages to plants as much as possible. The blending amount of water (d) is the amount of the remainder in % by mass which is determined by subtracting the amounts of the room-temperature volatile pyrethroid-based insecticidal component (a), the glycol ether compound (b), and the nonionic surfactant and/or anionic surfactant (c) as described above, from the amount of the aerosol stock solution, and is preferably in the range of about 70 to 95% by mass.

The aerosol stock solution preferably further contains (e) 15% by mass or less of a lower alcohol having carbon atoms of 2 or 3. The aerosol agent for insect pest control of the present invention may have some foaming properties, but by blending the lower alcohol, a defoaming effect is exhibited, which can improve the usability of the aerosol agent. The merit of blending a lower alcohol is significant particularly when the blending amount of the nonionic surfactant and/or anionic surfactant (c) is high. Ethanol and isopropanol (IPA) are representative of such a lower alcohol, and the blending amount thereof is desirably less than or equal to 15% by mass in the aerosol stock solution from the viewpoint of reducing the VOC content. It is noted that the blend of the lower alcohol also has the merit of easily adjusting an average particle size of atomized particles to 70 to 160 μm after atomizing when the aerosol agent is prepared using low-GWP gas as a propellant.

The aerosol agent for insect pest control of the present invention can also contain other components, such as a solvent, an acaricide, a repellent, a fungicide targeted to mold, fungi and the like, an antibacterial agent, a disinfectant, a stabilizer, a deodorant, an antistatic agent, a fragrance, an excipient, etc., as appropriate in the aerosol stock solution as long as they do not compromise the actions and effects of the present invention.

As a solvent, a hydrocarbon-based solvent such as an n-paraffin or an isoparaffin, an ester-based solvent, a ketone-based solvent, or the like can be used. Examples of the acaricide include 5-chloro-2-trifluoromethanesulfonamide methyl benzoate, phenyl salicylate, 3-iodo-2-propynyl butylcarbamate, and the like. Examples of the repellent include terpene-based insect repellent fragrances, such as diethyltoluamide, icaridin, terpineol, and geraniol, and the like. Examples of the fungicide, the antibacterial agent, and the disinfectant include 2-mercaptobenzothiazole, 2-(4-thiazolyl)benzimidazole, 5-chloro-2-methyl-4-isothiazolin-3-one, trifolin, 3-methyl-4-isopropylphenol, ortho-phenylphenol, and the like.

The aerosol agent for insect pest control of the present invention is prepared by filling a pressure-resistant container with the above-mentioned aerosol stock solution and a propellant. Low-GWP gas is preferable as the propellant. As the low-GWP gas, compressed gas (nitrogen gas, carbon dioxide, dinitrogen monoxide, compressed air, etc.) or HFO (hydrofluoro olefin) gas in which a GWP (Global Warming Potential) value [a global warming coefficient, i.e., a value expressing the intensity of global warming impact when CO2 is set to 1] is 10 or less, can be suitably used alone or in combination. Of the compressed gases, nitrogen gas and carbon dioxide are easy to use, and particularly, nitrogen gas is preferable. The use of compressed gas as the propellant can improve the efficiency of dispersal and adhesion of mist during the spray treatment, coarsen the atomized particle size, enhance safety against fire, and lessen the inhalation hazard of atomized particles. On the other hand, representative examples of the HFO gas include, but are not limited to, HFO-1234ze (trade name: Solstice ze) and HFO-1234yf (trade name: Solstice yf). Such HFO gas is a preferred propellant in the present invention because it is highly compatible with the aerosol stock solution and is considered not to be a VOC according to the standards of the United States EPA.

As long as the aerosol for insect pest control of the present invention does not impair its usefulness or does not exceed the VOC content, a small amount of a conventional propellant, such as liquefied petroleum gas (LPG), dimethyl ether (DME), or hydrofluorocarbon, can also be used together with the aerosol agent for the purpose of stabilizing the liquid. However, in view of the purpose of the present invention, it is preferred that the conventional propellant is not contained.

In the aerosol agent for insect pest control of the present invention, the average particle size of the aerosol stock solution after the spraying is preferably adjusted within the range of 70 to 160 μm. The average particle size within the range of 70 to 160 μm is relatively coarse for atomized particles, but it is found that such an average particle size range can efficiently form a barrier space using the room-temperature volatile pyrethroid-based insecticidal component (a) and can effectively contribute to the enhancement of the insect pest control effect, compared to when the average particle size of the aerosol stock solution after the spraying is fine.

The aerosol agent for insect pest control of the present invention can be provided with a valve, a button, a spraying outlet, a nozzle, or the like as appropriate, depending on its application, purpose of use, target insect pests, etc., but a spray button capable of spraying in an inverted posture is preferably loaded when taking into consideration the fact that the treatment target is mainly an outdoor solid-phase surface (for example, a floor surface of an outdoor (wooden or concrete) terrace or veranda, a surface of a vinyl sheet installed outdoors, the outdoor ground, or the like). When the aerosol stock solution is sprayed onto the outdoor solid-phase surface from the spray button together with the propellant such that the treatment amount of the room-temperature volatile pyrethroid-based insecticidal component (a) is within the range of 0.5 to 20 mg/m², preferably 60% by mass or more of the aerosol stock solution adheres to the solid-phase surface, and the room-temperature volatile pyrethroid-based insecticidal component (a) contained in the aerosol stock solution is volatilized from the solid-phase surface for four hours or more.

To form an effective barrier space, a certain amount of treatment area or more is needed. For example, when the surface to be treated is a flat surface, the treatment area is preferably 2 m or more×2 m or more (4 m² or more), and more preferably 3 m or more×3 m or more (9 m² or more). When the surface to be treated is set adjacent to a standing structure, such as a doorway of a veranda, a window sash, a tent doorway, or the like, spraying is preferably performed by setting the width of the surface to be treated along the standing structure to 1.5 m or more. The barrier space can vary depending on environmental conditions, but is defined as a space covering a height of about 2 to 2.5 m from the surface to be treated (the surface to be sprayed) as zero.

Specific situations where the present invention is applied include, in addition to those mentioned above, going in and out of terraces or balconies, drying laundry, going in and out of an entrance, outdoor life such as gardening in a garden, going in and out of tents in camping, outdoor barbecue, and lunch scenes at picnics, etc.

In the aerosol agent for insect pest control of the present invention, the glycol ether compound (b) also acts as the sensitivity reduction coping agent to the room-temperature volatile pyrethroid-based insecticidal component (a). Therefore, the aerosol agent for insect pest control of the present invention is extremely useful because it exhibits a practical insect pest control effect not only on insect pests with pyrethroid sensitivity, but also on insect pests with reduced sensitivity, particularly mosquitoes which include Culex species such as Culex pipiens, Culex tritaeniorhynchus, Culex quinquefasciatus, and Culex pipiens molestus; Aedes species such as Aedes albopictus and Aedes aegypti; and Chironomidae species. It is noted that such an effect is not a little recognized on various flying insect pests such as houseflies, drain flies, black flies, horseflies, biting midges, bees, and leafhoppers, and also creeping insect pests such as ants, wood louses, and sow bugs. However, this effect is characteristically exhibited on mosquitoes.

### EXAMPLES

Next, it will be explained on the basis of Examples that the aerosol agent for insect pest control of the present invention solves the VOC issues and exhibits an excellent insect pest control effect on insect pests with reduced sensitivity to pyrethroid-based insecticidal components.

### Example 1

First, (a) 0.22 g (0.11% by mass) of transfluthrin as the room-temperature volatile pyrethroid-based insecticidal component, (b) 3.0 g (1.5% by mass) of phenyldiglycol (boiling point: 283° C.), (c) 0.2 g (0.10% by mass) of polyoxyethylene styryl phenyl ether (activator N-1), 1.0 g (0.51% by mass) of polyoxyethylene styryl phenyl ether sulfate (activatorA-1), and (e) 21.6 g (27 mL, 11% by mass) of ethanol were put into a 200 mL pressure-resistant container to prepare a chemical mixture. Then, (d) water was added to the chemical mixture to afford a total of 200 mL (195 g) of aerosol stock solution. A valve was attached to the container, which was then filled with about 2 g of nitrogen gas through the valve by pressurizing, followed by loading a spray button capable of spraying in an inverted posture, on the container. In this way, an aerosol agent for insect pest control of Example 1 was obtained. The VOC content of the aerosol agent (aerosol stock solution) was calculated to be less than or equal to 15% by mass, which was determined not to cause any issues in terms of the VOC regulations. When the contents of the aerosol agent was sprayed from the valve, an average particle size of atomized particles was 97 μm.

The aerosol agent for insect pest control of Example 1 was sprayed in the inverted posture for about six seconds such that about 19 mg (about 3.2 mg/m²) of transfluthrin adhered to a wooden floor surface of 2 m×3 m in area adjacent to a veranda doorway. At this time, since the average particle size of the atomized particles sprayed from the valve of the aerosol agent was relatively as coarse as about 97 μm at this time, which is described above, the atomized particles did not significantly deviate and scatter from the treatment target, resulting in little risk of inhalation of the atomized particles. This makes it possible to perform the spray treatment with safety. The atomized particles dried out relatively quickly, and thus there was no need to worry about the slippage of a foot of a user or others on the treated floor surface. After the spray treatment, the adhesion amount of transfluthrin on the floor surface was analyzed, and the adhesion efficiency of the atomized particles was examined and found to be 84%, which was very high. Thereafter, a barrier space with transfluthrin was effectively formed above the treated floor surface, which could prevent insect pests, such as the Aedes albopictus, from interrupting a person when he/she was drying laundry at a veranda, and could also prevent flying insect pests from invading a room through the doorway of the veranda for 8 hours. In addition, similar tests were conducted in Thailand, where Culex quinquefasciatuses with reduced sensitivity to pyrethroid-based insecticidal components were observed to be alive here and there. As a result, the similar excellent insect pest control effect was demonstrated.

### Examples 2 to 14 and Comparative Example 1 to 9

Various aerosol agents of Examples 2 to 14 shown in Table 1 were prepared in accordance with Example 1, and then an adhesion test and a pest control efficacy test were conducted as follows. For comparison, the same tests as those in Examples were conducted on various aerosol agents of Comparative Examples 1 to 9 shown in Table 2. The contents (% by mass), shown in parentheses in Tables 1 and 2, of the room-temperature volatile pyrethroid-based insecticidal component (a), the glycol ether compound (b), and the nonionic surfactant and/or the anionic surfactant (c) were ones determined by calculation on the assumption that each of their specific gravities was 1.0.

(1) Adhesion Test of Aerosol Stock Solution onto Surface to be Treated

Glass plates with a total area of 0.583 m² (nine glass plates, each having an area of 24 cm×27 cm) were placed on the floor surface, and a sample aerosol agent was sprayed in the inverted posture for one second and applied to the glass plates from a distance of 50 cm above them. After analyzing an adhesion amount of pyrethroid-based insecticidal component per glass plate, the adhesion amount was converted into an adhesion amount per total area, and thereby an adhesion ratio (%) of the adhesion amount per total area to the amount of sprayed pyrethroid-based insecticidal component was calculated. The results are shown in Table 3.

### (2) Pest Control Efficacy Test Against Mosquitoes

The pest control efficacy test was conducted in a six-mat room with the door half-open. Specifically, an entrance door was opened with a 20-mesh net attached thereto, and a ventilation fan was activated (ventilation condition: about 5.3 times/hr). The glass plates with the total area of 0.583 m² to which each of the sample aerosol agents was sprayed and applied were held in another room for a predetermined time period in accordance with the adhesion test (1), and thereafter they were installed at the center of the floor surface in a test room. Then, about 100 test insects (Culex pipiens female adults with adequate sensitivity or reduced sensitivity to pyrethroid-based insecticidal components) were immediately released, and a tester walked around the treated glass plates and counted the number of accessions of the insects to both arms over time. The repellent ratio was determined based on the following formula. The results are shown in Table 3.

Repellent ratio (%)=[Number of flying insects in non-treated section−Number of flying insects in treated section]/[Number of flying insects in non-treated section]×100

TABLE 1

| | Aerosol agent for insect pest control (200 mL) | | | | | | | | | |
|---|---|---|---|---|---|---|---|---|---|---|
| | Aerosal stock solotion [g/200 mL (% by mass) [symbol] ¹] | | | | | | | | | |
| | (a) | | (c) Nonionic | | | | | Sprayed | | |
| | Pyrethroid- | (b) Glycol | surfactant | | | | | amount of | VOC | Average |
| | based | ether | and/or | | (e) | | | insecticidal | content | particle |
| | insecticidal | compound | Anionic | (d) | Lower | Other | | component | (% by | size |
| EXAMPLES | component | (trade name) | surfactant | Water | alchohol | components | Propellant | (mg/m²) | mass) [symbol] ² | (μm) |
| 2 | Transfluthrin | Phenyldiglycol | N-1 0.2 (0.10) | Remainder | Ethanol | — | Nitrogen | 5.5 | <15 | 97 |
| | 0.22 (0.11) | 3.0 (1.5) | A-1 1.0 (0.51) | | 21.6 (11) | | 2 g | | | |
| 3 | Transfluthrin | Phenyldiglycol | N-1 2.0 (0.10) | Remainder | — | — | Nitrogen | 5.5 | <15 | 103 |
| | 0.22 (0.11) | 3.0 (1.5) | A-1 1.0 (0.50) | | | | 2 g | | | |
| 4 | Transfluthrin | Phenyldiglycol | N-1 0.4 (0.21) | Remainder | Ethanol | — | Nitrogen | 5.5 | <20 | 85 |
| | 0.22 (0.11) | 5.2 (2.6) | A-1 1.7 (0.88) | | 28.8 (15) | | 2 g | | | |
| 5 | Transfluthrin | Phenyldiglycol | N-1 0.15 (0.07) | Remainder | Ethanol | — | Nitrogen | 5.5 | <15 | 91 |
| | 0.22 (0.11) | 1.5 (0.77) | A-1 0.8 (0.41) | | 21.6 (11) | | 2 g | | | |
| 6 | Transfluthrin | Benzyl glycol | N-1 0.2 (0.10) | Remainder | Ethanol | — | Nitrogen | 5.5 | <15 | 94 |
| | 0.22 (0.11) | 3.0 (1.5) | A-1 1.0 (0.51) | | 21.6 (11) | | 2 g | | | |
| 7 | Transfluthrin | Butyldiglycol | N-1 0.2 (0.10) | Remainder | Ethanol | — | Nitrogen | 5.5 | <15 | 97 |
| | 0.22 (0.11) | 3.0 (1.5) | A-1 1.0 (0.51) | | 21.6 (11) | | 2 g | | | |
| 8 | Transfluthrin | Phenyl | N-1 0.2 (0.10) | Remainder | Ethanol | Tea Leaf | HFO- | 5.5 | <15 | 73 |
| | 0.22 (0.11) | propylene | N-2 0.1 (0.05) | | 21.6 (11) | Dry | 1234ze | | | |
| | | glycol | A-1 1.0 (0.51) | | | Distilled | 20 g | | | |
| | | 3.0 (1.5) | | | | Solution | | | | |
| | | | | | | 0.1 | | | | |
| 9 | Transfluthrin | Phenyldiglycol | N-1 0.4 (0.21) | Remainder | Ethanol | — | Nitrogen | 5.5 | <15 | 97 |
| | 0.22 (0.11) | 3.0 (1.5) | | | 21.6 (11) | | 2 g | | | |
| 10 | Transfluthrin | Phenyldiglycol | A-1 1.0 (0.51) | Remainder | Ethanol | — | Nitrogen | 5.5 | <15 | 109 |
| | 0.22 (0.11) | 3.0 (1.5) | | | 21.6 (11) | | 2 g | | | |
| 11 | Metoiluithrin | Phenyldiglycol | N-1 0.2 (0.10) | Remainder | Ethanol | — | Nitrogen | 3.7 | <15 | 92 |
| | 0.14 (0.07) | 3.0 (1.5) | A-1 1.0 (0.51) | | 21.6 (11) | | 2 g | | | |
| 12 | Profluthrin | Methyl | N-3 0.3 (0.15) | Remainder | Iso- | Small | CO₂ | 7.6 | <12 | 86 |
| | 0.30 (0.15) | triglycol | N-5 0.1 (0.05) | | propanol | amount of | 3 g | | | |
| | | 4.2 (2.1) | A-2 1.2 (0.61) | | 16 (8.2) | fragrance | | | | |
| 13 | Transfluthrin | Phenyldiglycol | N-1 0.2 (0.10) | Remainder | Ethanol | — | Nitrogen | 5.5 | <15 | 94 |
| | 0.22 (0.11) | 1.0 (0.5) | A-1 1.0 (0.51) | | 21.6 (11) | | 2 g | | | |
| 14 | Transfluthrin | Phenyldiglycol | N-1 0.2 (0.10) | Remainder | Ethanol | — | Nitrogen | 5.5 | <25 | 88 |
| | 0.22 (0.11) | 20.0 (10.0) | A-1 1.0 (0.51) | | 21.6 (11) | | 2 g | | | |

[symbol]

¹_{'} [symbol] ² The content of each component and the VOC content are snown in ratio (% by mass) with respect-to the entire amount of aerosol agent. [symbol]
indicates data missing or illegible when filed

TABLE 2

| | Aerosol agent for insect pest control (200 mL) | | | | | | | | | |
|---|---|---|---|---|---|---|---|---|---|---|
| | Aerosal stock solotion [g/200 mL (% by mass) [symbol] ¹] | | | | | | | | | |
| | (a) | | (c) Nonionic | | | | | Sprayed | | |
| | Pyrethroid- | (b) Glycol | surfactant | | | | | amount of | VOC | Average |
| | based | ether | and/or | | (e) | | | insecticidal | content | particle |
| COMPARATIVE | insecticidal | compound | Anionic | (d) | Lower | Other | | component | (% by | size |
| EXAMPLES | component | (trade name) | surfactant | Water | alchohol | components | Propellant | (mg/m²) | mass) [symbol] ² | (μm) |
| 1 | Transfluthrin | — | N-1 0.2 (0.10) | Remainder | Ethanol | — | Nitrogen | 5.5 | <15 | 102 |
| | 0.22 (0.11) | | A-1 1.0 (0.51) | | 21.6 (11) | | 2 g | | | |
| 2 | Transfluthrin | Phenyldiglycol | N-1 1.1 (0.56) | Remainder | Ethanol | — | Nitrogen | 5.5 | <25 | 84 |
| | 0.22 (0.11) | 23 (12) | A-1 4.0 (2.1) | | 21.6 (11) | | 2 g | | | |
| 3 | Transfluthrin | Phenyldiglycol | N-1 0.8 (0.42) | Remainder | Ethanol | — | Nitrogen | 5.5 | [symbol] 34 | 74 |
| | 0.22 (0.12) | 18 (9.5) | A-1 3.0 (1.6) | | 44.8 (24) | | 2 g | | | |
| 4 | Transfluthrin | Isopropyl | N-1 0.2 (0.10) | Remainder | Ethanol | — | Nitrogen | 5.5 | <15 | 90 |
| | 0.22 (0.11) | glycol | A-1 1.0 (0.51) | | 21.6 (11) | | 2 g | | | |
| | | (boiling point: | | | | | | | | |
| | | 142° C.) | | | | | | | | |
| | | 3.0 (1.5) | | | | | | | | |
| 5 | Transfluthrin | — | N-1 0.2 (0.10) | Remainder | Ethanol | Propylene | Nitrogen | 5.5 | <15 | 90 |
| | 0.22 (0.11) | | A-1 1.0 (0.51) | | 21.6 (11) | glycol | 2 g | | | |
| | | | | | | 3.0 (1.5) | | | | |
| 6 | Transfluthrin | Phenyldiglycol | Lauryl | Remainder | Ethanol | — | Nitrogen | 5.5 | <15 | 86 |
| | 0.22 (0.11) | 3.0 (1.5) | Dimethylmine | | 21.6 (11) | | 2 g | | | |
| | | | Oxide | | | | | | | |
| | | | (ampholytic | | | | | | | |
| | | | surfactant? | | | | | | | |
| | | | 3.5 (1.8) | | | | | | | |
| 7 [symbol] ³ | Transfluthrin | Phenyldiglycol | N-1 0.2 (0.12) | Remainder | Ethanol | — | DME | 5.5 | [symbol] 58 | 35 |
| | 0.22 (0.14) | 3.0 (1.9) | A-1 1.0 (0.62) | | 21.6 (13) | | 100 mL | | | |
| | | | | | | | (41) | | | |
| 8 | dl.d-T80- | Phenyldiglycol | N-1 0.2 (0.10) | Remainder | Ethanol | — | Nitrogen | 10.7 | <15 | 129 |
| | ailethrin | 3.0 (1.5) | A-1 1.0 (0.51) | | 21.6 (11) | | 2 g | | | |
| | 0.45 (0.23) | | | | | | | | | |
| 9 | Transfluthrin | Phenyldiglycol | N-1 0.2 (0.10) | Remainder | Ethanol | — | Nitrogen | 5.5 | <15 | 95 |
| | 0.22 (0.11) | 0.8 (0.4) | A-1 1.0 (0.51) | | 21.6 (11) | | 2 g | | | |

[symbol]

¹_{'} [symbol] ² The content of each component and the VOC content are snown in ratio (% by mass) with respect to the entire amount of aerosol agent. [symbol]
3 The aerosol agent for insect pest control of Comparatve Example 7 contained 100 mL of the acresol stock solution with 100 mL of a propellant added thereto. [symbol]
indicates data missing or illegible when filed

TABLE 3

| | Adhesion test | Repetient ratio (%) | | | | | |
|---|---|---|---|---|---|---|---|
| | adhesion ratio | Culex pipiens with sensitivity | | | Culex pipiens with reduced sensitivity | | |
| EXAMPLES | (%) | After 3 h | After 8 h | After 12 h | After 3 h | After 8 h | After 12 h |
| 2 | 84 | 93 | 88 | 81 | 91 | 84 | 77 |
| 3 | 70 | 90 | 84 | 78 | 88 | 81 | 74 |
| 4 | 81 | 92 | 87 | 81 | 89 | 83 | 76 |
| 5 | 78 | 91 | 85 | 80 | 84 | 80 | 73 |
| 6 | 85 | 90 | 85 | 82 | 85 | 81 | 78 |
| 7 | 84 | 86 | 80 | 74 | 80 | 72 | 04 |
| 8 | 80 | 87 | 84 | 79 | 85 | 80 | 75 |
| 9 | 76 | 80 | 82 | 76 | 84 | 76 | 71 |
| 10 | 77 | 90 | 83 | 75 | 83 | 77 | 72 |
| 11 | 80 | 88 | 82 | 76 | 81 | 73 | 66 |
| 12 | 78 | 87 | 80 | 73 | 80 | 71 | 62 |
| 13 | 77 | 90 | 81 | 76 | 82 | 74 | 68 |
| 14 | 83 | 92 | 86 | 83 | 00 | 83 | 70 |
| COMPARATIVE | | | | | | | |
| EXAMPLES | | | | | | | |
| 1 | 75 | 86 | 79 | 65 | 78 | 62 | 45 |
| 2 | 76 | 79 | 74 | 63 | 75 | 65 | 63 |
| 3 | 80 | 91 | 87 | 81 | 89 | 83 | 74 |
| 4 | 73 | 84 | 73 | 50 | 79 | 62 | 45 |
| 5 | 77 | 82 | 71 | 62 | 73 | 50 | 44 |
| 6 | 74 | 83 | 74 | 66 | 80 | 67 | 52 |
| 7 | 45 | 67 | 58 | 50 | 64 | 51 | 47 |
| 8 | 78 | 30 | 31 | 27 | 30 | 25 | 20 |
| 9 | 75 | 90 | 78 | 74 | 80 | 65 | 61 |

As a result, it was found that the aerosol agent for insect pest control of the present invention which included the aerosol stock solution of the microemulsion type containing (a) 0.01 to 3.0% by mass of the room-temperature volatile pyrethroid-based insecticidal component, (b) 0.5 to 10% by mass of the glycol ether compound having a boiling point of 160 to 320° C., (c) 0.2 to 5.0% by mass of the nonionic surfactant and/or the anionic surfactant, and (d) the remainder in % by mass being water had the following features, wherein the pressure-resistant container provided with the spray button was filled with the aerosol stock solution: the VOC content was suppressed to 30% by mass or less; and when sprayed, 60% by mass or more of the aerosol stock solution adhered to the surface of the treatment target, and then the component (a) was gradually volatilized into a space above the surface of the treatment target, thereby exhibiting an excellent repellent effect on Culex pipiens with the adequate sensitivity to pyrethroid-based insecticidal components and Culex pipiens with reduced sensitivity thereto, for four to 12 hours. As clearly shown with reference to Examples 2, 11, and 12 and Comparative Example 8, transfluthrin, metofluthrin, and profluthrin were consistent with the object of the present invention as the pyrethroid-based insecticidal component, whereas dl,d-T80-allethrin was not suitable. Among them, it was confirmed that transfluthrin had high usefulness and exhibited only a small reduction in the pest control efficacy on the Culex pipienses with reduced sensitivity to the pyrethroid-based insecticidal components, compared to those with the adequate sensitivity to the pyrethroid-based insecticidal components, and therefore that transfluthrin was extremely effective in controlling these mosquitoes.

Comparative Example 3, which contained an excessive amount of ethanol, did not comply with the VOC regulations. Further, as shown in Comparative Example 7, even when DME was mainly used as the propellant instead of low-GWP gas, the VOC content exceeded 30% by mass, which was inappropriate. As shown in Comparative Example 2, if the blending amount of glycol ether compound becomes as excessive as 10% by mass or more, an excessive amount of surfactant will be also required, which may cause a problem of stickiness on a sprayed surface or the like. In addition, Comparative Example 4 in which the boiling point of the glycol ether compound deviated from the range of 160 to 320° C. was not preferable, either. Furthermore, as can be seen from comparison among Example 2, Example 9, and Example 10 with regards to the surfactant, the use of a combination of the nonionic surfactant and the anionic surfactant was preferable, whereas Comparative Example 6 using an ampholytic surfactant was inferior in performance. In Comparative Example 7, the adhesion ratio on the surface of the treatment target was inferior mainly due to the smaller average particle size, which also did not conform to the purpose of the present invention in this respect.

Further, the effect of the glycol ether compounds (b) having a boiling point of 160 to 320° C. also became evident. That is, from the comparison among Examples 2, 6, 7, and 8, and Comparative Examples 4 and 5, it was confirmed that phenyldiglycol, benzyl diglycol, butyl diglycol, and phenyl propylene glycol, which have a boiling point in the range of 160 to 320° C. and correspond to the glycol ether compounds (b) of the present invention, were also specifically effective on Culex pipiens with reduced pyrethroid sensitivity, whereby the actions of these compounds could be utilized as the sensitivity reduction coping agent. The aromatic-based glycol ether compounds of Example 2, Example 6, and Example 8 were more preferable in terms of performance than the aliphatic glycol ether compound of Example 7. In contrast, the glycol ether compound, which has a boiling point deviating from the range of 160 to 320° C. as in Comparative Example 4, as well as propylene glycol (Comparative Example 5, boiling point: 188° C.), which is exemplified as a volatilization regulator in Patent Documents 1 and 2 and is a different compound from the glycol ether compound, both contributed to the persistence of the repellent effect, but did not act sufficiently as the sensitivity reduction coping agent. As can be seen from the comparison among Examples 2, 13, and 14 and Comparative Example 9, it was confirmed that regarding the content of the glycol ether compound (b) having a boiling point of 160 to 320° C., by adjusting the content of the glycol ether compound at least within the range of 0.5 to 10% by mass, the glycol ether compound effectively acted as the sensitivity reduction coping agent for Culex pipienses with reduced sensitivity. Thus, conventional volatilization regulators (efficacy enhancers in the broad sense) do not necessarily correspond to the “sensitivity reduction coping agent”; however, the inventors have actually conducted the tests consistent with the object of the present invention by trial and error, and thereby have found for the first time that specific glycol ether compounds can become the “sensitivity reduction coping agent” intended in the present invention.

Accordingly, the aerosol agent for insect pest control and the insect pest control method of the present invention solve the VOC issues and are extremely practical because they are effective not only on insect pests with high sensitivity to pyrethroid-based insecticidal components, but also on insect pests with reduced sensitivity thereto, especially, mosquitoes, as mentioned above.

### INDUSTRIAL APPLICABILITY

The aerosol agent for insect pest control and the insect pest control method of the present invention are suitably used for outdoor applications, but they can obviously usable indoors as well and can also be used for a wide range of other insect pest control purposes.

1. An aerosol agent for insect pest control comprising an aerosol stock solution and a propellant, the aerosol agent being obtained by filling a pressure-resistant container provided with a spray button, with the aerosol stock solution and the propellant,
wherein a VOC content in the aerosol stock solution is 30% by mass or less, the aerosol stock solution comprising:
(a) 0.01 to 3.0% by mass of a room-temperature volatile pyrethroid-based insecticidal component that has a vapor pressure of 2×10⁻⁴ to 1×10⁻² mmHg at 30° C.;
(b) 0.5 to 10% by mass of a glycol ether compound having a boiling point of 160 to 320° C.;
(c) 0.2 to 5.0% by mass of a nonionic surfactant and/or an anionic surfactant; and
(d) the remainder in % by mass being water.

2. The aerosol agent for insect pest control of claim 1, wherein, when the aerosol stock solution is sprayed from the spray button onto an outdoor treatment target together with the propellant such that a treatment amount of the room-temperature volatile pyrethroid-based insecticidal component (a) is within a range of 0.5 to 20 mg/m², 60% by mass or more of the aerosol stock solution adheres to a surface of the treatment target, and
the room-temperature volatile pyrethroid-based insecticidal component (a) contained in the aerosol stock solution is volatilized from the surface for four hours or more.

3. The aerosol agent for insect pest control of claim 1, wherein the VOC content is 25% by mass or less.

4. The aerosol agent for insect pest control of claim 1, wherein the propellant is a compressed gas and/or HFO gas having a GWP value of 10 or less.

5. The aerosol agent for insect pest control of claim 1, wherein the aerosol stock solution further contains (e) 15% by mass or less of a lower alcohol having carbon atoms of 2 or 3.

6. The aerosol agent for insect pest control of claim 1, wherein an insect pest with reduced sensitivity to a pyrethroid-based insecticidal component is to be controlled.

7. The aerosol agent for insect pest control of claim 6, wherein the insect pest is a mosquito.

8. The aerosol agent for insect pest control of claim 1, wherein the room-temperature volatile pyrethroid-based insecticidal component is at least one selected from the group consisting of transfluthrin, metofluthrin, and profluthrin.

9. The aerosol agent for insect pest control of claim 8, wherein the room-temperature volatile pyrethroid-based insecticidal component is transfluthrin.

10. The aerosol agent for insect pest control of claim 1, wherein the glycol ether compound is an aromatic-based glycol ether compound.

11. The aerosol agent for insect pest control of claim 10, wherein the aromatic-based glycol ether compound is at least one selected from the group consisting of ethylene glycol monophenyl ether, ethylene glycol monobenzyl ether, diethylene glycol monophenyl ether, diethylene glycol monobenzyl ether, and propylene glycol monophenyl ether.

12. The aerosol agent for insect pest control of claim 1,
wherein the nonionic surfactant is at least one nonionic surfactant selected from the group consisting of a polyoxyethylene alkyl ether, a polyoxyethylene alkylphenyl ether, polyoxyethylene styryl phenyl ether, a polyoxyethylene-polyoxypropylene alkyl ether, a polyethylene glycol fatty acid ester, a polyoxyethylene sorbitan fatty acid ester, a polyoxyethylene glycerol fatty acid ester, a fatty acid polyalkanolamide, and
wherein the anionic surfactant is at least one anionic surfactant selected from the group consisting of a polyoxyethylene styryl phenyl ether sulfate, a polyoxyethylene alkyl ether sulfate, and a dodecyl benzene sulfate.

13. The aerosol agent for insect pest control of claim 1, wherein an average particle size of the aerosol stock solution sprayed from the spray button is within a range of 70 to 160 μm.

14. The aerosol agent for insect pest control of claim 1, wherein the treatment target is a floor surface of an outdoor terrace, a floor surface of an outdoor veranda, a surface of a vinyl sheet installed outdoors, or an outdoor ground.

15. An insect pest control method, comprising the steps of:
spraying the aerosol agent for insect pest control according to claim 1, onto an outdoor treatment target such that a treatment amount of the room-temperature volatile pyrethroid-based insecticidal component (a) is within a range of 0.5 to 20 mg/m²; and
volatilizing the room-temperature volatile pyrethroid-based insecticidal component (a) contained in the aerosol stock solution adhering to a surface of the treatment target, from the surface for four hours or more.

16. The insect pest control method according to claim 15, wherein an insect pest with reduced sensitivity to a pyrethroid-based insecticidal component is to be controlled.

17. The insect pest control method according to claim 16, wherein the insect pest is a mosquito.
